(19) United States
(12) Patent Application Publication
(10) Pub. No.: US 2002/0049590 A1
(43) Pub. Date: Apr. 25, 2002

(54) Speech data recording apparatus and method for speech recognition learning

(76) Inventors: Hiroaki Yoshino, Kanagawa (JP); Toshiaki Fukada, Tokyo (JP)

Correspondence Address: FITZPATRICK CELLA HARPER & SCINTO, 30 ROCKEFELLER PLAZA, NEW YORK, NY, 10112, US

(21) Appl. No.: 09/976,098

(22) Filed: Oct. 15, 2001

(30) Foreign Application Priority Data
Oct. 20, 2000 (JP) 321435/2000 (PAT.

(51) Int. Cl. G10L 15/12

(52) U.S. Cl. 704/241

(57) ABSTRACT

In a speech recording arrangement, a sentence to be recorded for speech recognition learning is presented to a user. Speech input by the user for the presented sentence is recognized to obtain a recognized character string. The speech pattern of the recognized character string is compared with the speech pattern of the presented sentence by DP matching to obtain a matching rate therebetween. It is determined whether the matching rate exceeds a predetermined level. If so, the input speech is recorded as learning data. If not, an unmatched portion between the recognized character string and the recording sentence is presented to the user. The user is then instructed to input the speech once again. With this arrangement, speech data with very few improperly pronounced words can be efficiently recorded.

### BACKGROUND OF THE INVENTION

1. Field of the Invention

The present invention relates to a speech data recording apparatus and method used for speech recognition learning, and also to a speech recognition system and method using the above-described speech data recording apparatus and method.

2. Description of the Related Art

Generally, an acoustic model and a speech database storing a large amount of speech data are used in speech recognition. In order to construct such an acoustic model and a speech database, a large amount of speech data must be recorded.

Speech recognition is generally performed according to the following procedure. Voice input through, for example, a microphone, is analog-to-digital (A/D) converted so as to obtain speech data. The voice input through the microphone contains unvoiced frames as well as voiced frames. Accordingly, the voiced frames are detected in the voice. Then, the voiced frames of the speech data are acoustically analyzed so as to calculate the features, such as cepstrum. The acoustic likelihood relative to a Hidden Markov Model (HMM) is then calculated from the features of the analyzed data. Thereafter, language searching is performed so as to obtain a recognition result.

The acoustic model includes data indicating the speech issued by various speakers in phonetic units, such as phonemes. In the speech recognition system, as pre-processing before starting speech recognition, a user is instructed to issue a few words or sentences, and based on such speech, the acoustic model is modified (learning). Thus, the recognition accuracy is improved. The speech recognition accuracy is largely determined by the acoustic model and the speech database storing a large amount of speech data. Thus, acoustic models and speech databases are becoming important.

With regard to the speech issued by the users for learning the acoustic model, it is assumed that the words or the sentences have been properly pronounced. Alternatively, only a simple determination is made as to whether the words or the sentences have been properly pronounced by using the recognition accuracy rate obtained by performing speech recognition on the words or sentences issued by the user. Additionally, an enormous amount of time in expended at high cost in recording and preparing a large amount of speech data in order to construct the speech database. Accordingly, there is an increasing demand for efficient recording of such speech data.

### SUMMARY OF THE INVENTION

Accordingly, in view of the foregoing, it is an object of the present invention to enable the efficient recording of speech data with very few improperly pronounced words by automatically checking whether speech is correctly input.

It is another object of the present invention to enable the recording of speech data with very few improperly pronounced words while reducing the time and the cost required for recording speech by allowing a user to easily identify mispronounced words while recording the speech.

In order to achieve the above objects, according to one aspect of the present invention, there is provided an apparatus for recording speech, which is used as learning data in speech recognition processing. The apparatus includes a storage unit for storing a recording character string indicating a sentence to be recorded. A recognition unit recognizes input speech used as the learning data so as to obtain a recognized character string. A determination unit compares the speech pattern of the recognized character string with the speech pattern of the recording character string stored in the storage unit so as to obtain a matching rate therebetween, and determines whether the matching rate exceeds a predetermined level. A recording unit records the input speech as the learning data when it is determined by the determination unit that the matching rate exceeds the predetermined level.

According to another aspect of the present invention, there is provided a method for recording speech, which is used as learning data in speech recognition processing. The method includes: a recognition step of recognizing input speech used as the learning data so as to obtain a recognized character string; a determination step of comparing the speech pattern of the recognized character string with the speech pattern of a recording character string so as to obtain a matching rate therebetween, and of determining whether the matching rate exceeds a predetermined level; and a recording step of recording the input speech as the learning data when it is determined in the determination step that the matching rate exceeds the predetermined level.

According to still another aspect of the present invention, there is provided a control program for allowing a computer to execute the aforementioned method.

According to a further aspect of the present invention, there is provided a speech recognition system including a storage unit for storing a recording character string indicating a sentence to be recorded. A recognition unit recognizes input speech. A determination unit compares the speech pattern of a recognized character string obtained by recognizing the input speech, which is to be used as learning data, by the recognition unit with the speech pattern of the recording character string stored in the storage unit so as to obtain a matching rate therebetween, and determines whether the matching rate exceeds a predetermined level. A recording unit records the input speech as the learning data when it is determined by the determination unit that the matching rate exceeds the predetermined level. A learning unit performs learning on a speech model by using the input speech recorded by the recording unit. The recognition unit performs speech recognition by using the speech data learned by the learning unit.

According to a further aspect of the present invention, there is provided a speech recognition method including: a learning recognition step of recognizing input speech, which is used as learning data, so as to obtain a recognized character string; a determination step of comparing the speech pattern of the recognized character string with the speech pattern of a recording character string indicating a sentence to be recorded so as to obtain a matching rate therebetween, and of determining whether the matching rate exceeds a predetermined level; a recording step of recording the input speech as the learning data when it is determined in the determination step that the matching rate exceeds the predetermined level; a learning step of performing learning on a speech model by using the input speech recorded in the recording step; and a regular recognition step of recognizing unknown input speech by using the speech model learned in the learning step.

According to a further aspect of the present invention, there is provided a control program for allowing a computer to execute the aforementioned speech recording method.

Other objects and advantages besides those discussed above shall be apparent to those skilled in the art from the description of preferred embodiments of the invention which follows. In the description, reference is made to accompanying drawings, which form a part thereof, and which illustrate examples of the invention. Such examples, however, are not exhaustive of the various embodiments of the invention, and therefore reference is made to the claims which follow the description for determining the scope of the invention.

### BRIEF DESCRIPTION OF THE DRAWINGS

FIG. 1 is a block diagram illustrating a speech recognition system in terms of speech recording functions according to a first embodiment of the present invention;

FIG. 2 is a block diagram illustrating the hardware configuration of a speech data recording apparatus according to the first embodiment;

FIG. 3 is a flow chart illustrating speech recording processing according to the first embodiment;

FIGS. 4A through 4D illustrate examples of the displayed recognition results obtained by performing dynamic programming (DP) matching according to the first embodiment;

FIGS. 5A and 5B illustrate further examples of the displayed recognition results obtained by performing dynamic programming (DP) according to the first embodiment;

FIGS. 6A and 6B illustrate additional examples of the displayed recognition results obtained by performing dynamic programming (DP) according to the first embodiment;

FIG. 7 illustrates an example in which the incorrectly pronounced portions in the recognition result are played back; and

FIG. 8 illustrates the configuration of a speech recognition system using the speech data recording apparatus of the first embodiment.

### DESCRIPTION OF THE PREFERRED EMBODIMENTS

The present invention is described in detail below with reference to the accompanying drawings through illustration of preferred embodiments.

### First Embodiment

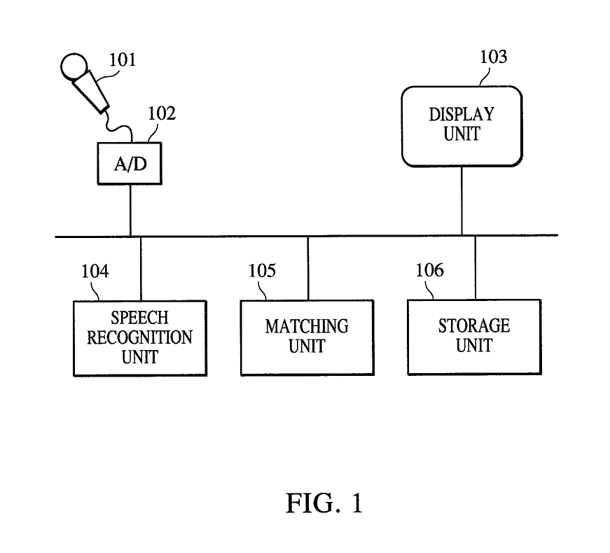

FIG. 1 is a block diagram illustrating a speech recognition system in terms of speech recording functions according to a first embodiment of the present invention. The speech recognition system shown in FIG. 1 includes the following elements to record speech for constructing a speech database and for learning an acoustic model.

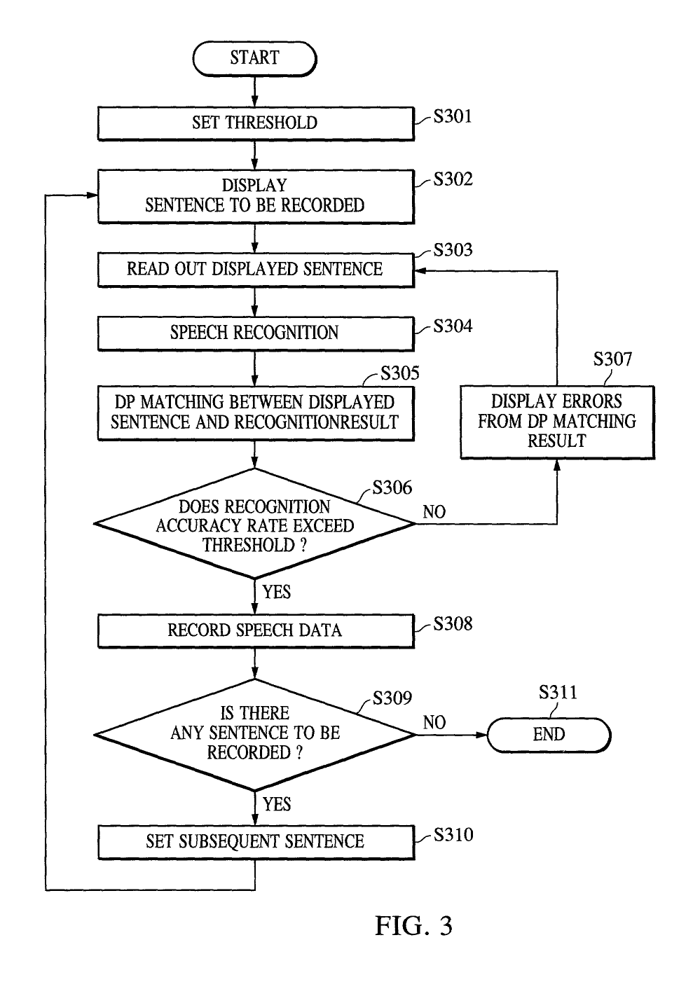

A speech input unit 101 converts the user's speech into an electrical signal. An A/D converter 102 then converts a sound signal from the speech input unit 101 into digital data. A display unit 103 displays a speech list indicating words or sentences to be recorded, and also displays a matching result obtained by a matching unit 105. A speech recognition unit 104 performs speech recognition based on the digital data obtained from the A/D converter 102. The matching unit 105 performs matching between the speech recognition result obtained in the speech recognition unit 104 and the speech list so as to determine the properly pronounced speech data. A storage unit 106 stores (records) such correct speech data. The speech recording processing is discussed in detail below with reference to the flow chart of FIG. 3.

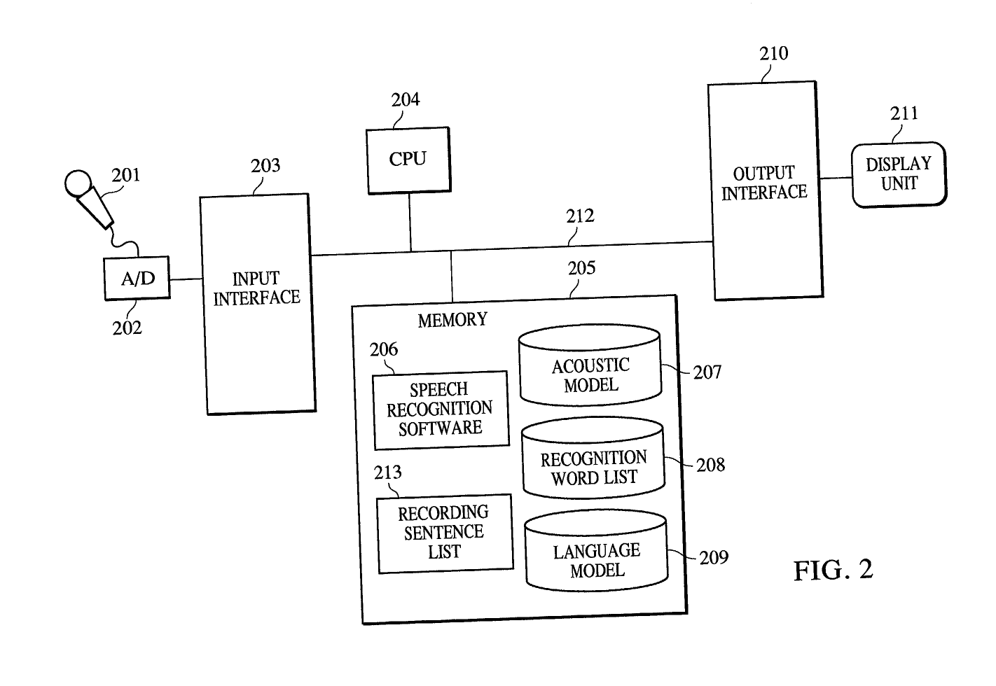

FIG. 2 is a block diagram illustrating the hardware configuration of a speech recording apparatus according to the first embodiment. A microphone 201 serves as the speech input unit 101 shown in FIG. 1. An A/D converter 202, which serves as the A/D converter 102, converts a sound signal from the microphone 202 into digital data (hereinafter referred to as “speech data”). An input interface 203 inputs the speech data obtained by the A/D converter 202 onto a computer bus 212.

A central processing unit (CPU) 204 performs computation so as to control the overall speech recognition system. A memory 205 can be referred to by the CPU 204. Speech recognition software 206 is stored in the memory 205. The speech recognition software 206 includes a control program for performing speech recording processing, and the CPU 204 executes this control program, thereby implementing the functions of the display unit 103, the speech recognition unit 104, the matching unit 105, and the storage unit 106. The memory 205 also stores an acoustic model 207 required for speech recognition and speech recording, a recognition word list 208, and a language model 209. A recording sentence list 213 indicating the content of the speech to be recorded is also stored in the memory 205.

An output interface 210 connects the computer bus 212 to a display unit 211. The display unit 211, which serves as the display unit 103 shown in FIG. 1, displays the content of the recording sentence list (speech list) 213 and the speech recognition result under the control of the CPU 204.

A description is now given, with reference to the flow chart of FIG. 3, of speech recording processing performed by the above-constructed speech recognition system according to the first embodiment.

In step S301, the recognition accuracy rate determined from the recognition result and the speech list 213 is set to be a threshold in order to determine whether user's speech is properly pronounced. Then, in step S302, a recording sentence registered in the speech list 213 is displayed on the display unit 211, thereby presenting the content of speech to the user. In step S303, when the user reads out the displayed sentence, the corresponding sound signal is input via the speech input unit 101 (201). Then, the sound signal is converted into speech data by the A/D converter 102 (202), and is stored in the memory 205. In step S304, the speech recognition unit 104 performs speech recognition processing on the speech data input in step S303, and the recognition result is stored in the memory 205.

Subsequently, in step S305, the matching unit 105 performs matching between the speech pattern of the recognition result obtained in step S304 and the speech pattern of the sentence presented in step S302, thereby determining the recognition accuracy rate. For the matching between the recognition result and the displayed sentence, a dynamic programming (DP) matching technique such as generally disclosed in U.S. Pat. No. 6,226,610 is used. In the DP matching technique, two patterns are non-linearly compressed so that the same characters in both patterns can be associated with each other. Accordingly, the minimum distance between the two patterns can be determined. Unmatched portions are handled as one of three types of errors, such as “insertion”, “deletion”, and “substitution”. Since the DP matching technique is known, a further explanation will be omitted.

It is then determined in step S306 whether the recognition accuracy rate determined in step S305 exceeds the threshold set in step S301. If the outcome of step S306 is yes, it can be determined that the sentence has been properly pronounced. If not, it can be determined that there is an error in the speech, and the process proceeds to step S307. In step S307, the errors are displayed on the display unit 211 from the DP matching result, and the process returns to step S303 in which the user is instructed to read the displayed sentence once again.

If it is found in step S306 that the speech has been properly issued, the process proceeds to step S308 in which the input speech data is recorded. It is then determined in step S309 whether there is a sentence to be recorded in the recording sentence list 213. If the outcome of step S309 is yes, the process proceeds to step S310 in which a subsequent sentence to be recorded is set. The process then returns to step S302. If it is found in step S309 that all the sentences have been read, the process proceeds to step S311 in which the processing is completed.

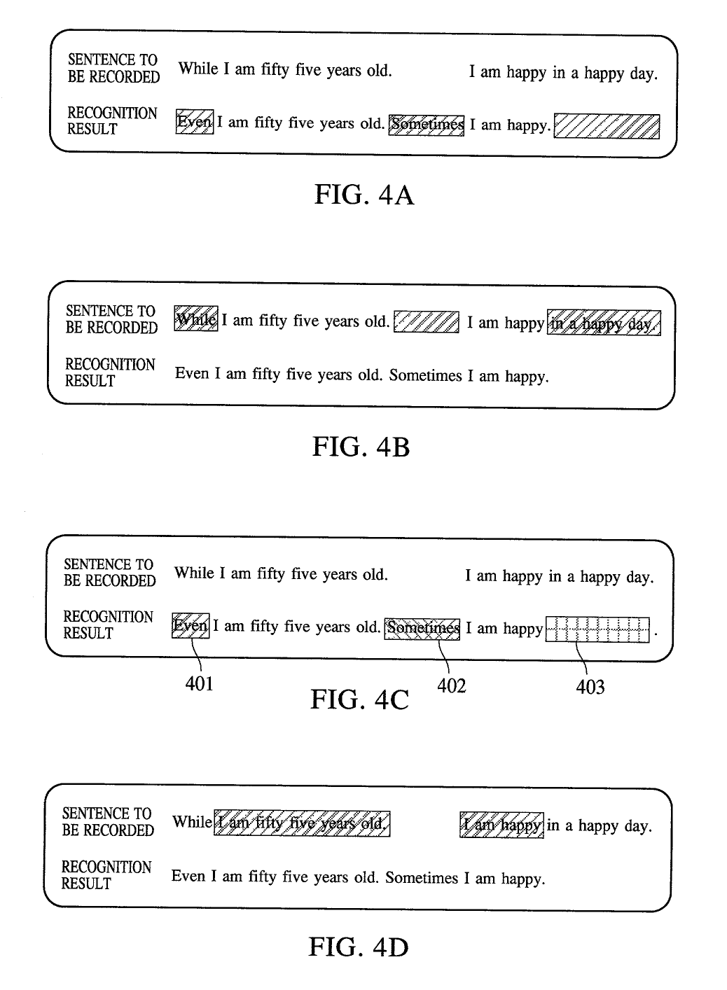

Various techniques for displaying the DP matching result in step S307 are considered. Several examples of the display techniques for the DP matching recognition result are given below, assuming that the recording sentences are “While I am fifty five years old. I am happy in a happy day.”, and the recognition result is “Even I am fifty five years old. Sometimes I am happy.” FIGS. 4A through 6B illustrate examples of the displayed DP matching recognition result.

FIG. 4A illustrates an example in which portions of the recognition result which differ from the recording sentence (i.e., recognition errors) are displayed in a different background color. FIG. 4B illustrates an example in which portions of the recording sentence which differ from the recognition result are displayed in a different background color. FIG. 4C illustrates an example in which portions of the recognition result which differ from the recording sentence (i.e., recognition errors) are divided into three types, such as “insertion”, “deletion”, and “substitution”, in the corresponding different background colors. More specifically, in an area 401, the word “while” in the recording sentence is substituted by another word “even”. In an area 402, a new word “sometimes” which is not contained in the recording sentence is inserted. In an area 403, the words “in a happy day” in the recording sentence are deleted. Thus, the areas 401, 402, and 403 are displayed in different background colors.

In the above-described examples, the background colors of the different portions are changed in either the recording sentence or the recognition result. Conversely, the background colors of the matched portions between the recording sentence and the recognition result may be changed. Such a modification is shown in FIG. 4D. In FIG. 4D, the background color of the matched portions in the recording sentence is changed. However, the background color in the recognition result may be changed.

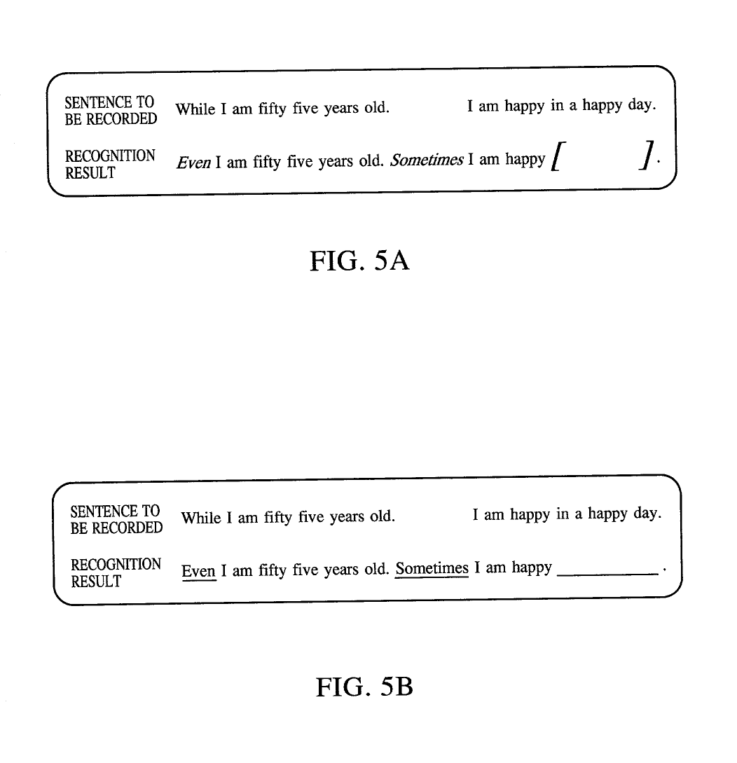

Although in FIGS. 4A through 4D the matched portions or the different portions are highlighted by changing the background color of the character strings, the character attribute may be changed instead of the background color. FIG. 5A illustrates an example in which the font of the portions of the recognition result which differ from those of the recording sentence is changed into italics. FIG. 5B illustrates an example in which the portions of the recognition result which differ from those of the recording sentence are underlined. Alternatively, the color of the characters may be changed, or the character font may be changed into a shaded font. The font may be changed according to the error type, as shown in FIG. 4C.

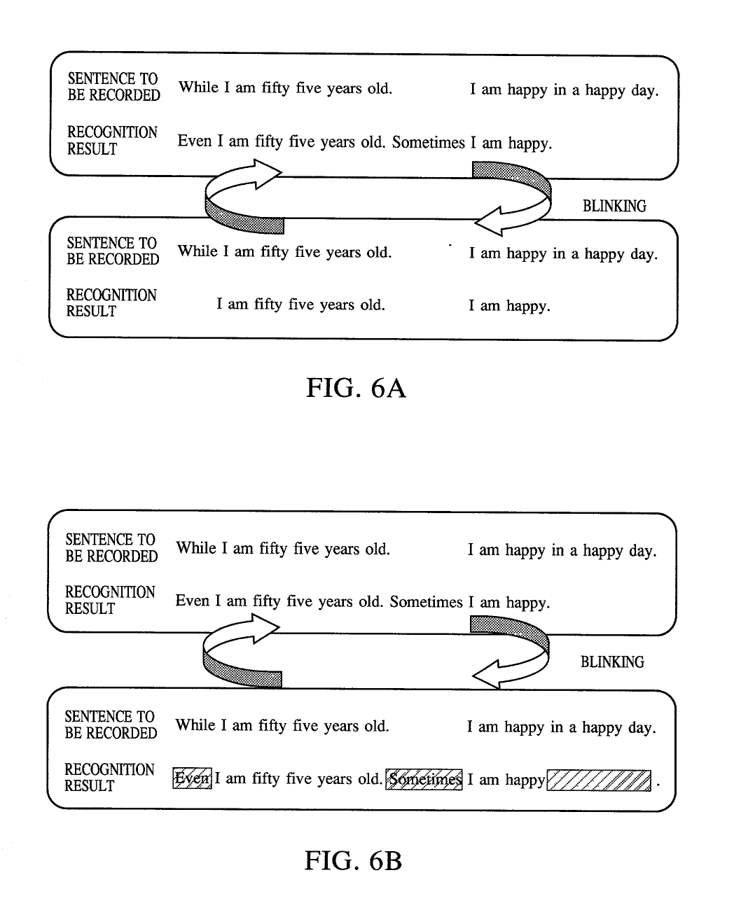

In the examples shown in FIGS. 4A through 5B, the different portions (or the matched portions) between the recording sentence and the recognition result are statically shown. However, they may be dynamically shown by, for example, causing the characters or the background to blink. FIG. 6A illustrates an example in which the different portions between the recording sentence and the recognition result are indicated by blinking. FIG. 6B illustrates an example in which the background of the different portions between the recording sentence and the recognition result is indicated by blinking. Alternatively, the characters or the background of the matched portions between the recording sentence and the recognition result may be shown by blinking.

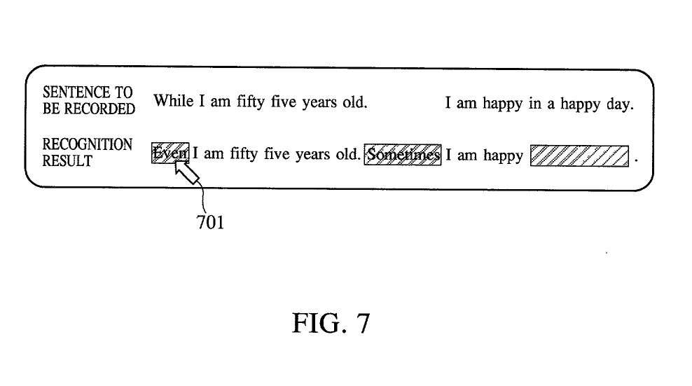

FIG. 7 illustrates an example in which the incorrectly pronounced portions in the recognition result are played back. The word graph obtained while performing speech recognition includes information indicating the start position and the end position of the speech corresponding to a recognized word. Thus, an incorrect word in the recognition result text is selected by clicking it with a mouse 701, and the start position and the end position of such an incorrect word are determined from the word graph. Then, the input speech of the incorrect word can be played back and checked.

As described above, according to the first embodiment, speech input for speech recognition learning is recognized, and then, the recognized character patterns (recognition result) are compared with the recording sentence patterns so as to determine the matching rate. It is then determined whether the input speech is to be recorded based on the matching rate. Accordingly, speech data with very few improperly pronounced words can be efficiently recorded.

Additionally, if it is determined that the matching rate does not exceed the threshold, the user is instructed to input the displayed sentence once again, thereby promoting efficient recording of the speech data. The matching rate is determined by using the DP matching technique, and thus, “insertion”, “deletion”, and “substitution” errors can be correctly identified.

According to the first embodiment, unmatched portions between the recording sentence and the recognition result are presented to the user. The user is thus able to easily identify the errors. The unmatched portions can be presented so that the user is able to identify the type of error, such as “insertion”, “deletion”, and “substitution”. As a result, the time and the cost required for recording speech can be reduced, and speech data having very few improperly pronounced words can be efficiently recorded.

### Second Embodiment

In the first embodiment, the speech recording functions for learning the acoustic model are described. In a second embodiment, a speech recognition system provided with this speech recording function is described below.

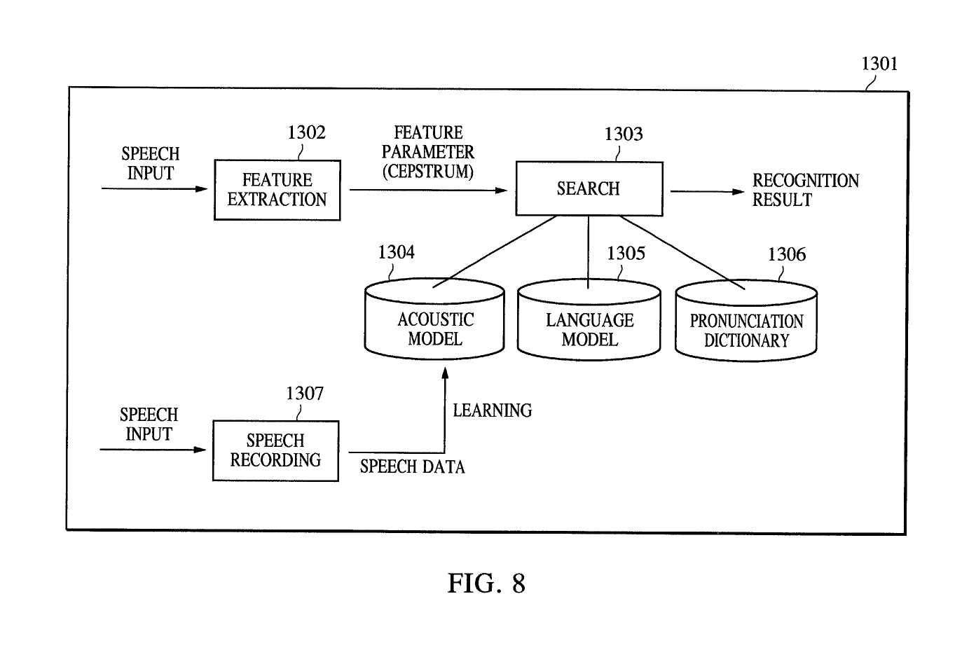

FIG. 8 illustrates the configuration of a speech recognition system 1301 using the speech data recording apparatus of the first embodiment. The speech recognition system 1301 extracts feature parameters from input speech by using a feature extraction unit 1302. Thereafter, a language search unit 1303 of the speech recognition system 1301 performs language searching by using an acoustic model 1304, a language model 1305, and a pronunciation dictionary 1306 so as to obtain a recognition result. In this embodiment, for improving the recognition accuracy, the acoustic model 1304 is taught to match the speaker. Before starting the speech recognition, a few learning samples are recorded so as to modify the acoustic model 1304. When recording the learning samples, a speech recording unit 1307 performs the speech recording processing shown in FIG. 3, thereby implementing learning of the acoustic model 1304.

As described above, according to the second embodiment, before starting the speech recognition, a few learning samples are recorded to modify the acoustic model. As a result, high-accuracy speech recognition can be performed.

As in the first embodiment, it is checked whether the speech to be recorded has been properly input. If not, the user is instructed to input the speech once again. Thus, speech data with very few improperly pronounced words can be efficiently recorded, and the recognition accuracy is further enhanced.

The present invention is applicable to a single device or a system consisting of a plurality of devices (for example, a computer, an interface, and a display unit) as long as the functions of the first or second embodiment are implemented.

The object of the present invention can also be achieved by the following modification. A storage medium for storing a software program code implementing the functions of the first or second embodiment may be supplied to a system or an apparatus. Then, a computer (or a CPU or an MPU) of the system or the apparatus may read and execute the program code from the storage medium.

In this case, the program code itself read from the storage medium implements the novel functions of the present invention. Accordingly, the program code itself, and means for supplying such program code to the computer, for example, a storage medium storing such program code, constitute the present invention.

Examples of the storage medium for storing and supplying the program code include a floppy disk, a hard disk, an optical disc, a magneto-optical disk, a compact disc read only memory (CD-ROM), a CD-recordable (CD-R), a magnetic tape, a non-volatile memory card, and a ROM.

The functions of the foregoing embodiments may be implemented not only by running the read program code on the computer, but also by wholly or partially executing the processing by an operating system (OS) running on the computer or in cooperation with other application software based on the instructions of the program code. The present invention also encompasses such a modification.

The functions of the above-described embodiments may also be implemented by the following modification. The program code read from the storage medium is written into a memory provided on a feature expansion board inserted into the computer or a feature expansion unit connected to the computer. Then, a CPU provided for the feature expansion board or the feature expansion unit partially or wholly executes processing based on the instructions of the program code.

When the above-described storage medium is used in the present invention, the program code corresponding to the above-described flow chart may be stored in the storage medium.

Although the present invention has been described in its preferred form with a certain degree of particularity, many apparently widely different embodiments of the invention can be made without departing from the spirit and the scope thereof. It is to be understood that the invention is not limited to the specific embodiments thereof, except as defined in the appended claims.

What is claimed is:

1. An apparatus for recording speech, to be used as learning data in speech recognition processing, comprising:
storage means for storing a recording character string indicating a sentence to be recorded;
recognition means for recognizing input speech used as the learning data so as to obtain a recognized character string;
determination means for comparing a pattern of the recognized character string with a pattern of the recording character string stored in said storage means so as to obtain a matching rate therebetween, and for determining whether said matching rate exceeds a predetermined level; and
recording means for recording the input speech as the learning data when it is determined by said determination means that said matching rate exceeds the predetermined level.

2. An apparatus according to claim 1, further comprising re-input instruction means for issuing an instruction to input speech once again when it is determined by said determination means that said matching rate does not exceed the predetermined level.

3. An apparatus according to claim 1, wherein said determination means determines said matching rate by performing DP matching between the recognized character string pattern and the recording character string pattern.

4. An apparatus according to claim 3, further comprising presentation means for presenting an unmatched portion between the recognized character string pattern and the recording character string pattern to a user as a result of performing the DP matching by said determination means.

5. An apparatus according to claim 4, wherein said presentation means presents the unmatched portion so as to identify the type of error as an insertion error, a missing error, or a substitute error, as a result of performing the DP matching by said determination means.

6. An apparatus according to claim 4, wherein said presentation means simultaneously displays the recognized character string and the recording character string on a screen by changing a character attribute or a background attribute of an unmatched portion or a matched portion of at least one of the recognized character string and the recording character string.

7. An apparatus according to claim 4, wherein said presentation means simultaneously displays the recognized character string and the recording character string on a screen by causing an unmatched portion or a matched portion of at least one of the recognized character string and the recording character string to blink.

8. A method for recording speech, to be used as learning data in speech recognition processing, comprising:
a recognition step of recognizing input speech used as the learning data so as to obtain a recognized character string;
a determination step of comparing a pattern of the recognized character string with a pattern of a recording character string so as to obtain a matching rate therebetween, and of determining whether said matching rate exceeds a predetermined level; and
a recording step of recording the input speech as the learning data when it is determined in said determination step that said matching rate exceeds the predetermined level.

9. A method according to claim 8, further comprising a re-input instruction step of issuing an instruction to input speech once again when it is determined in said determination step that said matching rate does not exceed the predetermined level.

10. A method according to claim 8, wherein said determination step determines said matching rate by performing DP matching between the recognized character string pattern and the recording character string pattern.

11. A method according to claim 10, further comprising a presentation step of presenting an unmatched portion between the recognized character string and the recording character string to a user as a result of performing the DP matching in said determination step.

12. A method according to claim 11, wherein said presentation step presents the unmatched portion so as to identify the type of error as an insertion error, a missing error, or a substitute error, as a result of performing the DP matching in said determination step.

13. A method according to claim 11, wherein said presentation step simultaneously displays the recognized character string and the recording character string on a screen by changing a character attribute or a background attribute of an unmatched portion or a matched portion of at least one of the recognized character string and the recording character string.

14. A method according to claim 11, wherein said presentation step simultaneously displays the recognized character string and the recording character string on a screen by causing an unmatched portion or a matched portion of at least one of the recognized character string and the recording character string to blink.

15. A speech recognition system comprising:
storage means for storing a recording character string pattern indicating a sentence to be recorded;
recognition means for recognizing input speech;
determination means for comparing a pattern of the recognized character string obtained by recognizing the input speech, which is to be used as learning data, by said recognition means with a pattern of the recording character string stored in said storage means so as to obtain a matching rate therebetween, and for determining whether said matching rate exceeds a predetermined level;
recording means for recording the input speech as the learning data when it is determined by said determination means that said matching rate exceeds the predetermined level; and
learning means for performing learning on a speech model by using the input speech recorded by said recording means,
wherein said recognition means performs speech recognition by using the speech data learned by said learning means.

16. A speech recognition method comprising:
a learning recognition step of recognizing input speech, to be used as learning data, so as to obtain a recognized character string;
a determination step of comparing a pattern of the recognized character string with a pattern of a recording character string indicating a sentence to be recorded so as to obtain a matching rate therebetween, and of determining whether said matching rate exceeds a predetermined level;
a recording step of recording the input speech as the learning data when it is determined in said determination step that said matching rate exceeds the predetermined level;
a learning step of performing learning on a speech model by using the input speech recorded in said recording step; and
a recognition step of recognizing unknown input speech by using the speech model learned in said learning step.

17. A control program having computer readable program code units for allowing a computer to execute a speech recording method, said speech recording method comprising:
a first program code unit for recognizing input speech used as the learning data so as to obtain a recognized character string pattern;
a second program code unit for comparing a pattern of the recognized character string with a pattern of a recording character string so as to obtain a matching rate therebetween, and of determining whether said matching rate exceeds a predetermined level; and
a third program code unit for recording the input speech as the learning data when it is determined in said determination step that said matching rate exceeds the predetermined level.

18. A control program for allowing a computer to execute a speech recognition method, said speech recognition method control program having computer readable program code units comprising:
a first program code unit for recognizing input speech, to be used as learning data, so as to obtain a recognized character string;
a second program code unit for comparing a pattern of the recognized character string with a pattern of a recording character string indicating a sentence to be recorded so as to obtain a matching rate therebetween, and of determining whether said matching rate exceeds a predetermined level;
a third program code unit for recording the input speech as the learning data when it is determined in said determination step that said matching rate exceeds the predetermined level;
a fourth program code unit for performing learning on a speech model by using the input speech recorded in said recording step; and
a fifth program code unit for recognizing unknown input speech by using the speech model learned in said learning step.
